(19) United States
(12) Patent Application Publication
(10) Pub. No.: US 2019/0215179 A1
(43) Pub. Date: Jul. 11, 2019

(54) AUTONOMOUS DATA DELIVERY AND RETRIEVAL SYSTEM

(71) Applicant: Carrier Corporation, Palm Beach Gardens, FL (US)

(72) Inventor: David Mannfeld, Palm Beach Gardens, FL (US)

(21) Appl. No.: 16/239,915

(22) Filed: Jan. 4, 2019

Related U.S. Application Data
(60) Provisional application No. 62/614,517, filed on Jan. 8, 2018.

(51) Int. Cl. H04L 12/28; B64C 39/02; H04L 12/24; H04W 4/80

(52) U.S. Cl. CPC H04L 12/2814; H04L 12/2834; B64C 2201/122; H04L 41/082; H04W 4/80; B64C 39/024

(57) ABSTRACT

An automated error monitoring system for intelligent appliances includes an unmanned drone having at least one of a short range wireless communication system and a physical data connection. The unmanned drone further includes a memory and a processor, with the memory storing instructions for causing the unmanned drone to move into a short range communication zone of an intelligent appliance, establish a data connection between the unmanned drone and the intelligent appliance, and perform a data transfer between the unmanned drone and the intelligent appliance.

### CROSS-REFERENCE TO RELATED APPLICATION

This application claims priority to U.S. Application No. 62/614,517 filed on Jan. 8, 2018.

### TECHNICAL FIELD

The present disclosure relates generally to data delivery and retrieval systems, and more specifically to a system and method for retrieving diagnostic data using automated or semi-automated drones.

### BACKGROUND

Modern residential and industrial appliances, such as heating ventilation and cooling (HVAC) appliances, incorporate controllers, sensors, computer software, and other complex electronics. Due to the incorporation of the complex electronics and computer controllers, these systems are referred to as “intelligent”. During operation of the intelligent HVAC appliances various errors can occur. When errors or abnormalities occur, intelligent HVAC appliances record diagnostic data and error data in a log file and store the log file locally in a memory unit.

In some appliances, an internet based reporting system is incorporated in the intelligent HVAC appliance that allows the HVAC appliance to report the diagnostic data to a base of operations over an internet connection. Such systems, however, require the end user to ensure that the HVAC appliance is connected to the internet and that proper connection is maintained and up to date. In practical reality it has been found that even when such an internet connection is possible, a substantial number of users do not properly maintain the connection, and the HVAC appliance is incapable of automatically reporting the diagnostic or error data to the base of operations.

When an end user reports an error, and the HVAC appliance is incapable of transmitting the diagnostic or error data over a network connection, a technician typically travels to the location of the HVAC appliance and retrieve the diagnostic data and error codes directly from the HVAC appliance. Using the diagnostic data and error codes, the technician can then determine a cause of the error and/or implement a potential solution to the error. Scheduling technicians to make a field visit can be expensive or time prohibitive as a time needs to be scheduled when both the owner and the technician are available to be at the unit.

### SUMMARY OF THE INVENTION

An exemplary method for interfacing with an intelligent appliance includes moving an unmanned drone into a short range communication zone of an intelligent appliance, establishing a data connection between the unmanned drone and the intelligent appliance, and performing a data transfer between the unmanned drone and the appliance.

In another example of the above described exemplary method for interfacing with an intelligent appliance performing the data transfer includes transferring a diagnostic data set from the intelligent appliance to the unmanned drone.

In another example of any of the above described exemplary methods for interfacing with an intelligent appliance performing the data transfer includes transferring at least one of a firmware update and a software update from the unmanned drone to the intelligent appliance.

Another example of any of the above described exemplary methods for interfacing with an intelligent appliance further includes providing instructions to the intelligent appliance causing the intelligent appliance to implement the at least one of the firmware update and the software update.

In another example of any of the above described exemplary methods for interfacing with an intelligent appliance establishing the data connection comprises establishing a physical data transfer connection.

In another example of any of the above described exemplary methods for interfacing with an intelligent appliance establishing the data connection comprises establishing a short range wireless communication connection.

Another example of any of the above described exemplary methods for interfacing with an intelligent appliance further includes storing data from the data transfer in a memory of the unmanned drone and returning the unmanned drone to a base of operations.

Another example of any of the above described exemplary methods for interfacing with an intelligent appliance further includes transferring data from the unmanned drone to a base of operations via a long range wireless connection, the data originating from the data transfer.

In another example of any of the above described exemplary methods for interfacing with an intelligent appliance the long range wireless connection is a cellular connection.

In another example of any of the above described exemplary methods for interfacing with an intelligent appliance movement of the unmanned drone is at least partially controlled by a human operator.

In another example of any of the above described exemplary methods for interfacing with an intelligent appliance the movement of the unmanned drone is fully automated.

In another example of any of the above described exemplary methods for interfacing with an intelligent appliance further includes generating at least ones of visual and audio data representative of the intelligent appliance.

In another example of any of the above described exemplary methods for interfacing with an intelligent appliance further includes automatically transferring a software patch from the unmanned drone to the intelligent appliance in response to receiving a diagnostic data set including data indicative of a problem having a known solution from the intelligent appliance.

In one exemplary embodiment an automated error monitoring system for intelligent appliances includes an unmanned drone including at least one of a short range wireless communication system and a physical data connection, and further including a memory and a processor, the memory storing instructions for causing the unmanned drone to move into a short range communication zone of an intelligent appliance, establish a data connection between the unmanned drone and the intelligent appliance, and perform a data transfer between the unmanned drone and the intelligent appliance.

In another example of the above described automated error monitoring system for intelligent appliances the unmanned drone further comprises a long range wireless communication system.

In another example of any of the above described automated error monitoring systems for intelligent appliances the long range wireless communication system is a cellular connection.

In another example of any of the above described automated error monitoring systems for intelligent appliances the unmanned drone further comprises at least one of an audio recording system and a video recording system.

In another example of any of the above described automated error monitoring systems for intelligent appliances the drone is fully autonomous.

In another example of any of the above described automated error monitoring systems for intelligent appliances the drone is semi-autonomous.

These and other features of the present invention can be best understood from the following specification and drawings, the following of which is a brief description.

### BRIEF DESCRIPTION OF THE DRAWINGS

FIG. 1 illustrates a high level schematic view of an exemplary system for automated diagnostic data retrieval

FIG. 2 illustrates a flowchart of a process for interfacing with an HVAC appliance according to the system of FIG. 1.

### DETAILED DESCRIPTION

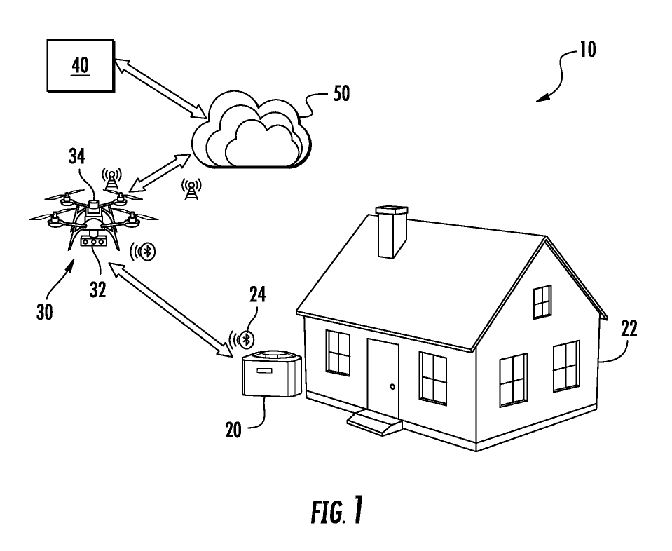

FIG. 1 schematically illustrates an exemplary system 10 for automatically retrieving diagnostic data from an HVAC appliance 20. In the exemplary system, the HVAC appliance 20 is an air conditioning unit for a residential home 22. In alternative embodiments the HVAC appliance 20 could be any similar intelligent appliance for either a residential home, or for an industrial campus, and is not limited to HVAC appliances. The HVAC appliance 20 includes a short range wireless communication system 24. By way of example, the short range wireless communication system 24 can be any standard wireless transmitter utilizing a Bluetooth or other standard wireless communication protocol.

Also included in the system 10 is a drone 30 equipped with a short range wireless communication system 32. The drone 30 in the exemplary embodiment is airborne, although alternative style drones could be used to the same effect. The short range wireless communication system 32 of the drone 30 is of the same type as the short range wireless communication system 24 of the HVAC appliance 20, and allows communication between the HVAC appliance 20 and the drone 30 when they are in range of each other. In some examples the drone 30 is further configured with a long range wireless communication system. The long range wireless communication system can include a cellular communication array 34. The cellular communication array 34 is configured to communicate with a base of operations 40, such as a dispatch center, via a network 50 such as the internet. Alternatively, any other long range wireless communication system capable of being carried by the drone 30 could be utilized to similar effect.

In a basic implementation of the system described herein, when a user at the residential home 22 encounters an error with the HVAC appliance 20, the user contacts the base of operations 40 to report the error. Upon receiving a reported error, the base of operations 40 dispatches a drone 30 to the home 22. While illustrated as an unmanned airborne drone, the dispatched drone 30 can be any type of autonomous, or semi-autonomous vehicle including the above described communications arrays. In alternative systems, the drone 30 can be dispatched pursuant to a maintenance schedule and not in response to a specific error.

Once dispatched, the drone 30 travels to the location of the HVAC appliance 20 experiencing the error. Once the drone 30 is within range of the short range wireless communication system 24 of the HVAC appliance 20, the short range wireless communication unit 32 of the drone 30 establishes a data connection with the short range wireless communication system 24 of the HVAC appliance 20. The data connection is primarily one way in some examples, allowing the drone 30 to receive a set of diagnostic or error data from the HVAC appliance 20. As used herein “primarily one way” refers to the transfer of data after an initial handshake establishing a data connection. In alternative examples, the data connection is a two way connection allowing for the drone 30 to receive diagnostic data and error data, and allowing the drone 30 to provide instructions or software updates to the HVAC appliance 20. By way of example the instructions provided to the HVAC appliance 20 can include software patches, firmware updates, and instructions altering the controller operations of the HVAC appliance 20.

In examples where the drone 30 includes long range wireless communications systems 34, the retrieved diagnostic and error data can be transmitted back to the base of operations 40 via the network 50 using any known file transfer protocol. In examples where the long range wireless communication system 34 is omitted, the retrieved diagnostic and error data is stored on an internal memory of the drone 30, and the drone 30 returns to the base of operations 40, where the data from the diagnostics and error logs can be analyzed and a solution can be determined.

In some further examples, the drone 30 can include visual or audio recording devices as well as the communications systems 32, 34. The visual and audio recording devices can store images, videos, and recordings of the operations of the HVAC appliance 20 while the drone 30 is dispatched to the HVAC appliance 20. Upon return to the base station 40, the images, video and audio recordings can be viewed by a technician and can further assist in identifying a necessary solution to any given error. By way of example, the drone 30 can utilize the visual recording device to record images of the HVAC appliance 20 experiencing the error, thereby allowing a user at the base of operations 40 to determine potential causes of the error. In systems where the drone 30 is equipped with long range communications systems 34, the audio visual media captured via the visual and audio recording devices can be streamed to the base of operations and does not need to be stored in the memory.

In an alternative example, the short range wireless communication systems 32 of the drone 30, and the short range wireless communications systems 24 of the HVAC appliance 20 can be replaced with a physical data connection. By way of example the data connection could be a known data interface such as a universal serial bus (USB) connection or a proprietary physical connection depending on the security needs of a given system. In such an example, the drone 30 can include control software configured to physically dock with the data connection on the HVAC appliance 20 thereby allowing for a direct physical connection. Alternatively, the drone 30 can include remote controls to allow an operator at the base of operations 40 to remotely control docking operations. Systems where the drone 30 is controlled during portions of its operations are referred to as semi-autonomous instead of autonomous operations.

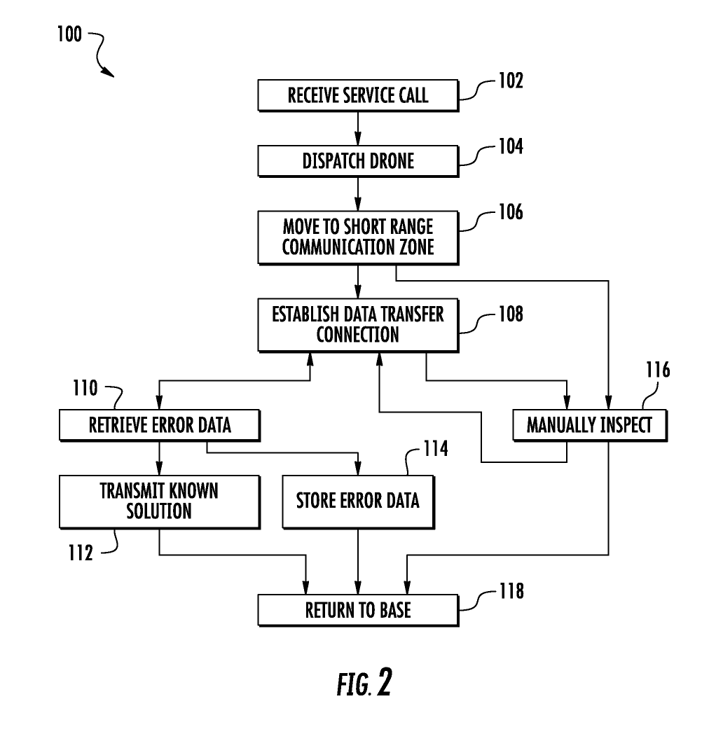

With continued reference to FIG. 1, FIG. 2 is a flowchart 100 illustrating a process for interfacing with the HVAC appliance 20 when a service call is placed by an end user of the HVAC appliance 20. To initiate the automated interfacing process, a service call is received at the base of operations 40 in a “Receive Service Call” step 102. Upon receipt of the service call request, the base of operations 40 dispatches an automated, or semi-automated, drone 30 to the geographic address of the HVAC appliance 20 experiencing the error in a “Dispatch Drone” step 104.

Once dispatched, the drone 30 moves into a short range communication zone of the HVAC appliance 20 in a “Move To Short Range Communication Zone” step 106. As described above, the short range communication zone can be a transmission range of a short range wireless communication system 24 of the HVAC appliance, or a docked position with a physical data connection. Once within the short range transmission zone, the drone 30 establishes a data transfer connection between the drone 30 and the HVAC appliance 20 in an “Establish Data Transfer Connection” step 108.

Once the data transfer connection is established, the drone 30 can retrieve a diagnostic data set or an error log from the HVAC appliance 20 in a “Retrieve Error Data” step 110. In some examples, the drone 30 can include software configured to analyze the diagnostic data and the error log, and determine the presence of errors having known solutions. This analysis can be performed using any known comparison or analysis system, and can be aided by transmitting the received data to an operator at the base of operations 40. In cases where there is a known solution capable of being implemented by the remote drone 30, the drone 30 transmits instructions configured to cause the HVAC appliance 20 controller to implement the known solution in a “Transmit Known Solution” step 112.

The known solution can include installation of a software patch, installation of a firmware upgrade, or a settings alteration to the HVAC appliance 20 that can address or rectify the problem. Transmitting the instructions to the HVAC appliance 20 causes a processor within the HVAC appliance 20 to apply the known solution. In alternative examples, where there is a standard software patch that should be applied irrespective of any existing errors, the drone 30 can skip straight to the “transmit known solution” step 112 and apply the software patch without requiring any analysis or retrieval of the stored error data.

Alternatively, once the drone 30 has retrieved the error data, an internal memory within the drone 30 will store the error data in a “Store Error Data” step 114, and the drone 30 can return to the base of operations 40 in a “Return to Base” step 118. Once returned, the data can be analyzed by a technician, and any potential solutions can be identified.

Alternatively, once within the short range communication zone, and either before or after establishing the data transfer connection, a drone 30 equipped with audio and/or visual recording equipment can inspect the HVAC appliance 20 and either store the recordings or transmit the recordings back to the base of operations in an “Inspect” step 116.

By utilizing automated, or semi-automated drones 30 to retrieve error data, and to implement known fixes, the labor costs associated with field reprogramming and accessing diagnostic data are reduced. Further, the need to schedule time where both an HVAC appliance 20 owner and a technician are available to be at the site is reduced.

While illustrated and described herein as related to HVAC appliances, one of skill in the art will appreciate that the system and concepts can be extended to any similar intelligent system and are not limited to HVAC applications. By way of non-limiting example, this concept could be extended to intelligent infrastructure, such as power lines, road signs, and the like.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A method for interfacing with an intelligent appliance comprising:
moving an unmanned drone into a short range communication zone of an intelligent appliance;
establishing a data connection between the unmanned drone and the intelligent appliance; and
performing a data transfer between the unmanned drone and the appliance.

2. The method of claim 1, wherein performing the data transfer includes transferring a diagnostic data set from the intelligent appliance to the unmanned drone.

3. The method of claim 1, wherein performing the data transfer includes transferring at least one of a firmware update and a software update from the unmanned drone to the intelligent appliance.

4. The method of claim 3, further comprising providing instructions to the intelligent appliance causing the intelligent appliance to implement the at least one of the firmware update and the software update.

5. The method of claim 1, wherein establishing the data connection comprises establishing a physical data transfer connection.

6. The method of claim 1, wherein establishing the data connection comprises establishing a short range wireless communication connection.

7. The method of claim 1, further comprising storing data from the data transfer in a memory of the unmanned drone and returning the unmanned drone to a base of operations.

8. The method of claim 1, further comprising transferring data from the unmanned drone to a base of operations via a long range wireless connection, the data originating from the data transfer.

9. The method of claim 8, wherein the long range wireless connection is a cellular connection.

10. The method of claim 1, wherein movement of the unmanned drone is at least partially controlled by a human operator.

11. The method of claim 1, wherein the movement of the unmanned drone is fully automated.

12. The method of claim 1, further comprising generating at least ones of visual and audio data representative of the intelligent appliance.

13. The method of claim 1, further comprising automatically transferring a software patch from the unmanned drone to the intelligent appliance in response to receiving a diagnostic data set including data indicative of a problem having a known solution from the intelligent appliance.

14. An automated error monitoring system for intelligent appliances comprising:
an unmanned drone including at least one of a short range wireless communication system and a physical data connection, and further including a memory and a processor, the memory storing instructions for causing the unmanned drone to move into a short range communication zone of an intelligent appliance, establish a data connection between the unmanned drone and the intelligent appliance, and perform a data transfer between the unmanned drone and the intelligent appliance.

15. The automated error monitoring system of claim 14, wherein the unmanned drone further comprises a long range wireless communication system.

16. The automated error monitoring system of claim 15, wherein the long range wireless communication system is a cellular connection.

17. The automated error monitoring system of claim 14, wherein the unmanned drone further comprises at least one of an audio recording system and a video recording system.

18. The automated error monitoring system of claim 14, wherein the drone is fully autonomous.

19. The automated error monitoring system of claim 14, wherein the drone is semi-autonomous.
